(19) United States
(12) Patent Application Publication
(10) Pub. No.: US 2021/0112809 A1
(43) Pub. Date: Apr. 22, 2021

(54) METHODS FOR REDUCING THE VOLATILITY AND TOXICITY OF CLOMAZONE

(71) Applicant: FMC Corporation, Philadelphia, PA (US)

(72) Inventor: Paul NICHOLSON, Ewing, NJ (US)

(21) Appl. No.: 16/493,939

(22) PCT Filed: Mar. 12, 2018
(86) PCT No.: PCT/US2018/021996

§ 371 Date: Sep. 13, 2019

Related U.S. Application Data
(60) Provisional application No. 62/470,458, filed on Mar. 13, 2017.

(51) Int. Cl. A01N 43/56; A01N 43/80; A01N 25/02

(52) U.S. Cl. CPC A01N 43/56; A01N 25/02; A01N 43/80

(57) ABSTRACT

The present application describes formulations of clomazone having unexpected reduced volatility in a non-encapsulated emulsifiable concentrate (EC) formulation. The discovery that the volatility of clomazone can be reduced in a non-encapsulated formulation by the addition of certain second active compounds is surprising, and can provide the benefit of faster delivery of clomazone to treated crops, while reducing the damage to neighboring vegetation as a result of clomazone volatility.

### FIELD OF THE DISCLOSED SUBJECT MATTER

The present invention relates to the field of agrochemical compositions, formulations, and methods of use of agrochemical compositions and formulations.

### BACKGROUND

Clomazone, the common name for 2-(2-chlorophenyl)methyl-4,4-dimethyl-3-isoxazolidinone is an active ingredient in highly effective herbicides that are selective against perennial weeds, including grasses and broadleaves. Clomazone works by inhibiting the biosynthesis of carotenoids in the plant; a plant affected by clomazone exhibits progressive whitening with increased dosage. It may be formulated in the form of an emulsifiable concentrate (EC) or microencapsulated form (ME).

Clomazone is considered to be highly volatile. When it is applied to soil in a target area, under certain conditions clomazone may migrate or diffuse to adjacent areas causing whitening or bleaching of beneficial plants near treated fields. While this whitening and bleaching on non-targeted plants, indicative of the mode of action of clomazone, may be temporary when plants are exposed to sufficiently low concentrations, it is unwelcome, even when it does not result in the destruction of the plant.

Accordingly, the label for the use of clomazone-containing herbicides, such as Command® (in the US, FMC Corporation), Gamit 480 EC (in Brazil, FMC Corporation), and Centium® (in Europe, FMC Corporation), lists a number of restrictions on how the herbicide is to be used, including weather conditions, spray volume and pressure, droplet size, and distance from areas where plants are in commercial production. For example, for preemergent applications, clomazone-containing herbicide is not to be applied within 1,500 feet (500 meters) of commercial fruit, nut, or vegetable production or commercial greenhouses or nurseries.

It is sometimes useful to use a second or third agricultural agent along with clomazone to broaden the spectrum of activity. In order to maintain volatility control over both ingredients, microencapsulated formulations of clomazone and a second active ingredient within the microcapsule have been described in U.S. Pat. No. 6,440,902 to Szamosi. However, some agricultural agents are incompatible with clomazone and do not decrease volatility when mixed with clomazone. Aside from the manufacturing challenges of encapsulating clomazone, the process may further complicate pesticidal outcomes, for example if clomazone's availability is delayed due to its entrapement in respective microcapsules. Thus, there is a need in the art for clomzaone formulations in combination with a second active agent that have better volatility profile while avoiding some or all of the shortcomings associated with microencapsulation of clomazone.

### SUMMARY OF THE INVENTION

The present invention discloses novel non-encapsulated clomozone compositions that demonstrate surprising low volatility. The present invention is also directed to methods for reducing the volatility of a clomazone EC containing composition, where the clomzaone is not in an encapsulated form, i.e., clomazone is non-encapsulated (or unencapsulated).

One aspect of the invention is directed to a method for reducing the volatility of clomazone comprising preparing a composition comprising (i) an EC of clomazone and (ii) a second active ingredient, wherein the entire composition is water-free and wherein the second active ingredient effectively suppresses the volatility of clomazone.

Another aspect of this invention is a method for reducing the volatility of clomazone, comprising preparing a composition that includes a water-free EC of clomazone, a second active ingredient, at least one surfactant, and at least one emulsifier.

In one embodiment of this method, the second active ingredient can be selected from the group consisting of selected from the group consisting acetochlor, aclonifen, alachlor, ametryn, dimethachlor, dimethanamide, dimethenamid-P, carfentrazone ethyl, ethalfluralin, linuron, metazachlor, napropamide, napropamide-M, metolachlor, S-metolachlor, pendimethalin, propanil, agriculturally acceptable esters thereof and mixtures of two or more thereof. In a preferred embodiment, the second active ingredient is metazachlor.

Another aspect of this invention is directed to a formulation obtained by mixing water with a water-free composition comprising an EC of non-encapsulated clomazone and a second active ingredient. In a preferred embodiment, the formulation is an oil in water emulsion (EW) formulation.

In one embodiment, the formulation is prepared from a water-free EC of clomazone by mixing clomazone and a second active ingredient in the substantial absence of water. The formulation is prepared by a process comprising the steps: combining a water-free clomazone emulsion concentrate and a second active component.

A formulation obtained according to the process described herein provides a low volatility clomazone mixture of non-encapsulated clomazone, having a lower clomazone volatility than comparable non-encapsulated clomazone formulations. Clomazone volatility is determined according to the methods described herein. A clomazone formulation prepared by the methods of the present invention has clomazone volatility of less than about 50%, or less than about 45%, or less than about 40%, or less than about 35%.

Another aspect of the invention includes a method for treating crops, which includes (a) filling a spray tank one-half to three-fourths full with an aqueous solution, such as water or liquid fertilizer; (b) adding a water-free composition comprising an EC of clomazone and a second active ingredient to the spray tank; (c) adding enough water or liquid fertilizer to fill the spray tank; (d) providing sufficient agitation during mixing and application to maintain a uniform spray mixture; and (e) applying the spray mixture to target crops.

The water-free composition in the disclosed method optionally includes a third active ingredient wherein the second active ingredient is different from the third active ingredient.

### DETAILED DESCRIPTION OF THE INVENTION

Reference will now be made in detail to exemplary embodiments of the disclosed subject matter. The method and corresponding steps of the disclosed subject matter will be described in conjunction with the detailed description of the disclosed invention.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

The applicants retain the right to limit or exclude certain components which may be deemed to affect the novelty, inventiveness or effectiveness of the invention claimed by use of the language “consisting of” or “consisting essentially of”, which are understood in the context of the present invention to have the conventional meaning accorded under the generally accepted rules of claim construction. In any case, the applicants reserve the right to expressly exclude any element from the prior art that is not considered critical to the function of the claimed invention without prejudice to the invention claimed.

As used herein, the term “about” generally refers to plus or minus 1% of the indicated value. For example, “about 10%” may indicate a range of 9% to 11%, and “about 20” may mean from 18 to 22. Other meanings of “about” may be apparent from the context, such as rounding off, so, for example “about 1” may also mean from 0.5 to 1.4. The absence of “about” from the text should not necessarily limit the scope of the invention, unless it is clear from the context that such limitation is intended.

The term “clomazone” as used in the present disclosure means a composition comprising at least 90% by weight pure 2-(2-chlorophenyl) methyl-4,4-dimethyl-3-isoxazolinone. In one embodiment the clomazone may be technical grade clomazone with purity range of 90 to 95% by weight. In another embodiment, the clomazone may be a composition comprising more than 95% by weight pure 2-(2-chlorophenyl) methyl-4,4-dimethyl-3-isoxazolinone. The term “pure clomazone” means 100% pure 2-(2-chlorophenyl) methyl-4,4-dimethyl-3-isoxazolinone.

The terms “volatility control” or “clomazone volatility control” refer to the result of the clomazone test detailed in Example 2, with the reference compound being Command® 4EC (in the United States, FMC Corporation), also known as Gamit 480 EC (in Brazil, FMC Corporation), and Centium® EC (in Europe, FMC Corporation). That is, Command® 4EC has 0% volatility control. A theoretical formulation that allowed no clomazone to evaporate would have 100% volatility control. Volatility control is measured using the methodology in Keifer et al. (Keifer, D. W., Dexter, R. W., Nicholson, O., and Pepper, R. F., “Microencapsulation Clomazone: Formulation Stability, Tank Mix Volatility, and Solvent Effects,” J. of ASTM International Vol. 4, No. 3, 2007, pp. 1-10). “% Volatility Control (or, alternatively, “% VC”)” is the volatility of the sample divided by the volatility of the clomazone EC standard subtracted from 1 and then multiplied by 100; that is, % VC=1−V_{S}/V_{C}, where V_{S} is the measured volatility of the clomazone sample and V_{C} is the measured volatility of a standard clomazone emulsifiable concentrate.

The term “liquid fertilizer” refers to a fertilizer in a fluid or liquid form containing various ratios of nitrogen, phosphorous and potassium (for example, but not limited to, 10% nitrogen, 34% phosphorous and 0% potassium) and micronutrients, commonly known as starter fertilizers that are high in phosphorus and promote rapid and vigorous root growth. Liquid fertilizers are commonly aqueous-based. As used herein, the term “aqueous-based” indicates that the predominant solvent or vehicle is water.

The present invention discloses methods for reducing the volatility of a clomazone EC containing composition in a non-encapsulating form. It has been found that mixing clomazone EC with certain second active ingredients leads to volatility of 40%-50%. This result is unexpected, because Command® 4EC has 0% volatility control (that is, 100% volatility), and typically, the addition of active ingredients is not expected to reduce clomazone volatility control.

Emulsifiable concentrate formulations of clomazaone and at least a second active component provide volatility control of from about 10% to about 70%, or from about 20% to about 65%, or from about 30% to about 60%; or from about 35% to about 55%; or from about 40% to about 50%; or from about 45% to about 50%; or from about 47% to about 50%.

The second active component can be one selected from: acetochlor; aclonifen; alachlor; ametryn; dimethachlor; dimethanamide; dimethenamid-P; carfentrazone ethyl; ethalfluralin; linuron; metazachlor; napropamide; napropamide-M; metolachlor; S-metolachlor; pendimethalin; propanil agriculturally acceptable esters thereof and mixtures of two or more thereof.

In another embodiment, the emulsifiable concentrate can optionally include a third active ingredient selected from the group consisting of: acetochlor; aclonifen; alachlo; ametryn; dimethachlor; dimethanamide; dimethenamid-P; carfentrazone ethyl; ethalfluralin; linuron; metazachlor; napropamide; napropamide-M; metolachlor; S-metolachlor; pendimethalin; propanil; butachlor; delachlor; diethatyl; ethachlor; pretilachlor; propachlor; propisochlor; prynachlor; terbuchlor; thenylchlor; xylachlor; Diphenamid; naptalam; pethox-amid; pretilachlor; benzofluor; cambendichlor; chloramben; dicamba; bispyribac; pyrithiobac; mesotrione; sulcotrione; te-furyltrione; tembotrione; benfuresate; asulam; barban; alloxydim; isoxaflutole; dinitramine; dipropalin; pendimethalin; acifluorfen; etnipromid; fluoronitrofen; fomesafen; imazamethabenz; bromobonil; methiozolin; monisouron; pyroxasulfone; topramezone; bromofenoxim; clomeprop; 2-(2,4-dichlorophenoxy)ethanol benzoate (2,4-DEB); et-nipromid; clacyfos; (4-Chlorophenoxy)acetic acid (4-CPA); 2,4-Dichlorophenoxyacetic acid (2,4-D); 4-(2,4-Dichlorophenoxy)butanoic acid (2,4-DB); 4-(3,4-Dichlorophenoxy)butanoic acid (3,4-DB); cloprop; 2-(4-Chlorophenoxy)propanoic acid (4-CPP); dichlorprop; chlora-zifop; clodinafop; clofop; cyhalofop; kuicaoxi; metamifop; propaquizafop; quizalofop; difenzoquat; halosulfuron; fluazolate; brompyrazon; clopyralid; diflufenican; atrazine; chlorazine; cyanazine; cyprazine; trietazine; indaziflam; ametryn; methoprotryne; simetryn; terbutryn; ethiozin; hexazinone; metribuzin; amicarbazone; bencarbazone; carfentrazone; sulfentrazone; thiencarbazone; cloransulam; isoproturon; methiuron; metobromuron; metoxuron; tetrafluron; thidiazuron; amidosulfuron; cyclosulfamuron; ethoxysulfuron; flucetosulfuron; metsulfuron; prosulfuron; thifensulfu-ron; tebuthiuron; acrolein; flurtamone; fluthiacet-methyl; funaihecaoling; agriculturally acceptable esters thereof; and mixtures of two or more thereof, wherein the second active ingredient is different from the third active ingredient.

The compositions and formulations of the present disclosure can be in any conventional agriculturally useful form, for example, in the form of a twin pack, or in a ready-to-use formulation, or in the form of a tank mix. Additionally, the active compounds can be supplied (either separately or pre-mixed) in any appropriate formulation type, for example an emulsifiable concentrate (EC), a suspension concentrate (SC), a suspo-emulsion (SE), a capsule suspension (CS), a water dispersible granule (WG), an emulsifiable granule (EG), a water in oil emulsion (EO), an oil in water emulsion (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a dispersible concentrate (DC), a wettable powder (WP) or any other technically feasible formulation in combination with agriculturally acceptable adjuvants. In one preferred embodiment, the compositions of the present disclosure are supplied as an emulsifiable concentrate, a suspension concentrate or a capsule suspension.

As is known in the art of agricultural formulations, an emulsifiable concentrate is a liquid composition that when mixed with water creates a stable mixture that requires little or no agitation after properly mixing. It typically turns a milky white forming an oil in water emulsion on dilution.

By the phrase “substantially water free” or “water-free” or “in the substantial absence of water” it is meant that the water content of the water-free composition is less than 2.5% weight by weight. By the phrase “water free” it is meant that the water content of the subject compositions are less than 0.5% weight by weight or there is no water in the composition.

In at least one embodiment of the present invention, the active ingredients are present in concentrations ranging from 0.01% to about 95%. In a more preferred embodiment, the active ingredients may be present in concentrations of about 1%, 5%, 10%, 15%, 20%, 25%, 30%, 35%, 40%, 45%, 50%, 55%, 60%, 65%, 70%, 75%, 80%, 85%, 90%, and 95%.

Surfactants, emulsifiers, viscocity enhancing agents, and solvents can constitute between about 1% to 20% of the final formulation by weight. Such agents include a blend of 80% calcium dodecyl benzene sulfonate and 20% 6 mole ethylene oxide adduct of nonyl phenol (Niagara 1), A blend of 60% calcium dodecyl benzene sulfonate and 40% 30 mole ethylene oxide adduct of nonyl phenol (Niagara 2); polyalkylene oxide block copolymer (alpha butyl omega-hydroxypoly(oxypropylene) block polymer with poly-(oxyethylene)—MW=2400-3500 (Niagara 3); disubstituted Amide (Hallcomid M8-10) Rhodasurf, Rhodacal, Antarox® B848 (Emulsifyer) and mixtures thereof. In one preferred embodiment, the compositions of the present invention can be formulated as an EC, SC, or CS.

One aspect of the disclosed invention covers a method for reducing the bleach-related toxicity of clomazone by combining clomazone with a second active ingredient, wherein the non-target plots are not as damaged as they would be if exposed to clomazone without the second active ingredient. The effect of clomazone compositions on non-target plots is tested using the barrel test.

At least one aspect of the present invention is the surprising observation that combining clomazone with a second active ingredient reduces the amount of bleaching of the crops that were not inside the barrel. In at least one embodiment, one of ordinary skill in the art can appreciate that the reduction of the amount of bleaching of the crop is about 15, 25, 30, 40, 50, 60 or 70 percent as compared to the control compositions.

The clomazone emulsifiable concentrates of the present invention are substantially water-free but can include any organic solvent or solvent mixture that easily dissolves or suspends clomazone, and that is immiscible with water. Among suitable water-immiscible inert organic solvents in which clomazone may be dissolved are mixtures of mono- and polyalkylated aromatics commercially available from Shell Oil Co. under the trademark SHELLSOL; various petroleum fluids available from Exxon such as Aromatic 200, Aromatic 100, Aromatic 150ND, AE700, and Exxate 700; various fatty acid methyl esters available from Henkel Corporation, such as Emery 2209, Emery 2270, and Emery 2301; and edible oils such as soy bean oil, corn oil, sunflower oil, vegetable oil, peanut oil, and canola oil. Any of these solvents can be used alone or in a mixture with any one or more of the other solvents.

The organic solvent of the present embodiment may also be animal fats or oils, or a vegetable oil. Vegetable oils usable in the present embodiment can be any lipid materials derived from plants, provided that the lipid material is immiscible with water, the lipid material easily dissolves clomazone, and the lipid material does not contain chemical groups reactive to isocyanates such as amines, alcohols, free acids, and the like. Chemically, vegetable oils may be described as triglycerides. Under one aspect of the present embodiment, the vegetable oil contains a mixture of triglycerides, diglycerides, monoglycerides, free fatty acids and unsaponifiable lipids. Suitable vegetable oils within the scope of the present embodiment include edible oils, biofuel oils, drying oils, and other oils that are of plant origin. The edible oils usable in the present embodiment include almond oil, avocado oil, coconut oil, corn oil, cottonseed oil, diacylglycerol (DAG) oil, ghee, grape seed oil, groundnut oil, hemp oil, lard, margarine, mustard oil, olive oil (including extra light, virgin, extra virgin, and refined), palm oil, peanut oil, rapeseed oil, canola oil, rice bran oil, safflower oil, sesame oil (including semi-refined and unrefined), soybean oil, sunflower oil (including high oleic, and linoleic), tea seed oil, and walnut oil. Biofuel oils usable in the present embodiment include castor oil, coconut oil, colza oil, corn oil, cottonseed oil, false flax oil, hemp oil, mustard oil, palm oil, peanut oil, radish oil, rapeseed oil, ramtil oil, rice bran oil, safflower oil, salicornia oil, soybean oil, tigernut oil, tung oil, copaiba, honge oil, jatropha oil, jojoba oil, milk bush, nahor oil, paradise oil, and petroleum nut oil. Drying oils usable in the present embodiment include dammar oil, flaxseed oil, linseed oil, poppyseed oil, stillingia oil, tung oil, and vernonia oil.

In one aspect of the present invention, the methods of the present invention include compositions and formulations that selectively protect crops that are a member of the any of the following crop groups including, bananas, beans, beets, cassava, cereals, citrus, cocoas, coconuts, coffee, corn, cotton, fiber crops, flowers, forge corps, forestry, groundnuts, peanuts, hops, horticultures, non-land crops, oil palm, oilseed rape, peas, pomes, potato, rice, stonefruit, spices, sugar cane, Sunflower, tea, tobacco, tomatoes, tree nuts, turf, vegetable crops, vines, grapes. In at least one embodiment, the crops are potato, soybean, corn, rice, sorghum, oil seed rape, barley, rye, cowpea or canola.

More specifically, such crops include, but are not limited to, bananas, plantains, beet: fodder, beets, sugar beets, cassava, barley, barley-spring, barley-winter, oats, oats+triticale-winter, oats-spring, oats-winter, rye, rye-winter, stubble, triticale, triticale+rye, wheat, wheat/barley, wheat-durum, wheat-spring, wheat-winter, citrus, grapefruit, lemons/limes, oranges, cocoa, coconuts, coffee, corn, corn: fodder, corn: grain, corn: sweet, corn+sorghum-spring, cotton, flax, carnation, chrysanthemum, flowers, gladioli, ornamentals: nursery, roses, alfalfa, brassicas: fodder, clover: seed, forage crops, grass-seed, pasture, rangeland, rye: seed, forestry, groundnuts, peanuts, hops, horticulture, industrial markets, aquatic weed control, fallow land, idle crop land, land reclamation, summer fallow, oil palm, canola, rapeseed, rapeseed-spring, rapeseed-winter, linseed, lupin, mustard, oil seeds, safflower seed, sesame seed, olives, berries, blackberries, cranberries, currants, durians, guavas, kiwifruit, lychees, mangoes, papayas, persimmon, pineapple, rambutans, strawberries, tropical fruits, beans, chick-peas, lentils, mung beans, peas, pulses/gram, apples, apricots, avocados, cherries, fruit, peaches, nectarines, pears, plums, pome fruit, pome/stone fruit, tree crops: waxapples, potatoes, potatoes: seed, potatoes: sweet, rice, rice: paddy, rice: upland, rubber, millet, sm.grain: other, sorghum, soybeans, cardamom, cloves, ginsing, pepper: black, spices, sugar cane, sunflower, tea, tobacco, tomatoes, field tomatoes, green tomatoes, red tomatoes, almonds, betel nuts, cashews, hazelnuts, macadamia nuts, pecans, pistachios, walnuts, turf/lawns, agave, asparagus, brassicas: vegetable, broccoli, cabbage, Chinese cabbage, carrots, chicory, cruciferae, cucumbers, cucurbits, eggplant, garlic, herbs, lettuce, melons, onions, onions/garlic, peppers/chillies, field peppers, Japanese radish, squash, vegetable crops, field vegetables, other vegetables, watermelons, and grapes. Cucurbits include such crops as Melons, Benincasa spp., Citrullus spp., Cucumis spp., Momordica spp., Watermelon, Citrullus lanatus, Pumpkin, Cucurbita pepo, Squash, Cucurbita argyrosperma, C. ficifolia, C. maxima, C. moschata, and Cucumber: Cucumis sativus. In one embodiment, the crop includes wheat varieties such as Bloc, Kord, Wyalkatchem and Mace.

This aspect may be used to control weeds comprising applying an herbicidally effective amount of any of the above compositions or formulations to an area where weeds are present. The preferred plants that are controlled by this method include grasses and broadleaves. Specifically, the weeds may be controlled by this method include those selected from the group consisting of barnyard grass, broadleaf signalgrass, crabgrass, foxtail, goosegrass, panicum, Johnsongrass, cupgrass, field sandbar, Bermuda grass, red rice, itch grass, velvetleaf, spurred anoda, common ragweed, Jimsonweed, Lambsquarter, Pennsylvania smartweed, prickly sida, purslane, redweed, Venice mallow, cocklebur, dayflower, Florida beggarweed, Florida pusley, Kochia, redvine, tropic croton, wild pointsettia, balloonvine, black nightshade, curly dock, joint vetch, and morning glory.

In one aspect of the present invention, the composition used in the disclosed methods is water-free. The water-free composition can be used on an agricultural field. When the water-free composition is used on an agricultural field, the user measures out the appropriate amount of the herbicide into a farm tank, a spray tank or a similar container, in which the water-free composition is mixed with water to generate an aqueous suspension of the composition.

The compositions, formulations, and methods of the invention can be applied simulataneously with, or sequentially with, other suitable additional or secondary agricultural active ingredients, or other suitable additional agricultural compositions such as insecticides, herbicides, fungicides, nematicides and plant growth regulators. The compositions, formulations, and methods can also be applied simultaneously or sequentially with liquid fertilizers. Specifically, in one embodiment, the water-free compositions can be mixed with a liquid fertilizer in a tank mix to create an EW formulation, and the EW formulation can then be applied to target crops or weeds. Suitable additional insecticides, herbicides, fungicides, nematicides and plant growth regulators can include the following:

Insecticides: A0) various insecticides, including agrigata, al-phosphide, amblyseius, aphelinus, aphidius, aphidoletes, artimisinin, Autographa californica NPV, azocyclotin, Bacillus subtilis, Bacillus thuringiensis- spp. aizawai, Bacillus thuringiensis spp. kurstaki, Bacillus thuringiensis, Beauveria, Beauveria bassiana, betacyfluthrin, biologicals, bisultap, brofluthrinate, bromophos-e, bromopropylate, Bt-Corn-GM, Bt-Soya-GM, capsaicin, cartap, celastrus-extract, chlorantraniliprole, chlorbenzuron, chlorethoxyfos, chlorfluazuron, chlorpyrifos-e, cnidiadin, cryolite, cyanophos, cyantraniliprole, cyhalothrin, cyhexatin, cypermethrin, dacnusa, DCIP, dichloropropene, dicofol, diglyphus, diglyphus+dacnusa, dimethacarb, dithioether, dodecyl-acetate, emamectin, encarsia, EPN, eretmocerus, ethylene-dibromide, eucalyptol, fatty-acids, fatty-acids/salts, fenazaquin, fenobucarb (BPMC), fenpyroximate, flubrocythrinate, flufenzine, formetanate, formothion, furathiocarb, gamma-cyhalothrin, garlic-juice, granulosis-virus, harmonia, Heliothis armigera NPV, inactive bacterium, indol-3-ylbutyric acid, iodomethane, iron, isocarbofos, isofenphos, isofenphos-m, isoprocarb, isothioate, kaolin, lindane, liuyangmycin, matrine, mephosfolan, metaldehyde, metarhizium-anisopliae, methamidophos, metolcarb (MTMC), mineral-oil, mirex, m-isothiocyanate, monosultap, Myrothecium verrucaria, naled, Neochrysocharis formosa, nicotine, nicotinoids, oil, oleic-acid, omethoate, orius, oxymatrine, paecilomyces, paraffin-oil, parathion-e, pasteuria, petroleum-oil, pheromones, phosphorus-acid, photorhabdus, phoxim, phytoseiulus, pirimiphos-e, plant-oil, Plutella xylostella GV, polyhedrosis-virus, polyphenol-extracts, potassium-oleate, profenofos, prosuler, prothiofos, pyraclofos, pyrethrins, pyridaphenthion, pyrimidifen, pyriproxifen, quillay-extract, quinomethionate, rape-oil, rotenone, saponin, saponozit, sodium-compounds, sodium-fluosilicate, starch, steinernema, streptomyces, sulfluramid, sulphur, tebupirimfos, tefluthrin, temephos, tetradifon, thiofanox, thiometon, transgenics (e.g., Cry3Bb1), triazamate, trichoderma, trichogramma, triflumuron, verticillium, vertrine, isomeric insecticides (e.g., kappa-bifenthrin, kappa-tefluthrin), dichoromezotiaz, broflanilide, pyraziflumid; A1) the class of carbamates, including aldicarb, alanycarb, benfuracarb, carbaryl, carbofuran, carbosulfan, methiocarb, methomyl, oxamyl, pirimicarb, propoxur and thiodicarb; A2) the class of organophosphates, including acephate, azinphos-ethyl, azinphos-methyl, chlorfenvinphos, chlorpyrifos, chlorpyrifos-methyl, demeton-S-methyl, diazinon, dichlorvos/DDVP, dicrotophos, dimethoate, disulfoton, ethion, fenitrothion, fenthion, isoxathion, malathion, methamidaphos, methidathion, mevinphos, monocrotophos, oxymethoate, oxydemeton-methyl, parathion, parathion-methyl, phenthoate, phorate, phosalone, phosmet, phosphamidon, pirimiphos-methyl, quinalphos, terbufos, tetrachlorvinphos, triazophos and trichlorfon; A3) the class of cyclodiene organochlorine compounds such as endosulfan; A4) the class of fiproles, including ethiprole, fipronil, pyrafluprole and pyriprole; A5) the class of neonicotinoids, including acetamiprid, clothianidin, dinotefuran, imidacloprid, nitenpyram, thiacloprid and thiamethoxam; A6) the class of spinosyns such as spinosad and spinetoram; A7) chloride channel activators from the class of mectins, including abamectin, emamectin benzoate, ivermectin, lepimectin and milbemectin; A8) juvenile hormone mimics such as hydroprene, kinoprene, methoprene, fenoxycarb and pyriproxyfen; A9) selective homopteran feeding blockers such as pymetrozine, flonicamid and pyrifluquinazon; A10) mite growth inhibitors such as clofentezine, hexythiazox and etoxazole; A11) inhibitors of mitochondrial ATP synthase such as diafenthiuron, fenbutatin oxide and propargite; uncouplers of oxidative phosphorylation such as chlorfenapyr; A12) nicotinic acetylcholine receptor channel blockers such as bensultap, cartap hydrochloride, thiocyclam and thiosultap sodium; A13) inhibitors of the chitin biosynthesis type 0 from the benzoylurea class, including bistrifluron, diflubenzuron, flufenoxuron, hexaflumuron, lufenuron, novaluron and teflubenzuron; A14) inhibitors of the chitin biosynthesis type 1 such as buprofezin; A15) moulting disruptors such as cyromazine; A16) ecdyson receptor agonists such as methoxyfenozide, tebufenozide, halofenozide and chromafenozide; A17) octopamin receptor agonists such as amitraz; A18) mitochondrial complex electron transport inhibitors pyridaben, tebufenpyrad, tolfenpyrad, flufenerim, cyenopyrafen, cyflumetofen, hydramethylnon, acequinocyl or fluacrypyrim; A19) voltage-dependent sodium channel blockers such as indoxacarb and metaflumizone; A20) inhibitors of the lipid synthesis such as spirodiclofen, spiromesifen and spirotetramat; A21) ryanodine receptor-modulators from the class of diamides, including flubendiamide, the phthalamide compounds (R)-3-Chlor-N1-{2-methyl-4-[1,2,2,2-tetrafluor-1-(trifluormethyl)ethyl]phenyl}-N2-(1-methyl-2-methylsulfonylethyl)phthalamid and (S)-3-Chlor-N1-{2-methyl-4-[1,2,2,2-tetrafluor-1-(trifluormethyl)ethyl]phenyl}-N2-(1-methyl-2-methylsulfonylethyl)phthalamid, chloranthraniliprole and cy-anthraniliprole; A22) compounds of unknown or uncertain mode of action such as azadirachtin, amidoflumet, bifenazate, fluensulfone, piperonyl butoxide, pyridalyl, sulfoxaflor; or A23) sodium channel modulators from the class of pyrethroids, including acrinathrin, allethrin, bifenthrin, cyfluthrin, lambda-cyhalothrin, cypermethrin, alpha-cypermethrin, beta-cypermethrin, zeta-cypermethrin, deltamethrin, esfenvalerate, etofenprox, fenpropathrin, fenvalerate, flucythrinate, tau-fluvalinate, permethrin, silafluofen and tralomethrin.

Fungicides: B0) benzovindiflupyr, anitiperonosporic, ametoctradin, amisulbrom, copper salts (e.g., copper hydroxide, copper oxychloride, copper sulfate, copper persulfate), boscalid, thiflumazide, flutianil, furalaxyl, thiabendazole, benodanil, mepronil, isofetamid, fenfuram, bixafen, fluxapyroxad, penflufen, sedaxane, coumoxystrobin, enoxastrobin, flufenoxystrobin, pyraoxystrobin, pyrametostrobin, triclopyricarb, fenaminstrobin, metominostrobin, pyribencarb, meptyldinocap, fentin acetate, fentin chloride, fentin hydroxide, oxytetracycline, chlozolinate, chloroneb, tecnazene, etridiazole, iodocarb, prothiocarb, Bacillus subtilis syn., Bacillus amyloliquefaciens (e.g., strains QST 713, FZB24, MBI600, D747), extract from Melaleuca alternifolia, extract from Lupinus albus doce, BLAD polypeptide, pyrisoxazole, oxpoconazole, etaconazole, fenpyrazamine, naftifine, terbinafine, validamycin, pyrimorph, fthalide, probenazole, isotianil, laminarin, estract from Reynoutria sachalinensis, phosphorous acid and salts, teclofthalam, triazoxide, pyriofenone, organic oils, potassium bicarbonate, chlorothalonil, fluoroimide; B1) azoles, including bitertanol, bromuconazole, cyproconazole, difenoconazole, diniconazole, enilconazole, epoxiconazole, fluquinconazole, fenbuconazole, flusilazole, flutriafol, hexaconazole, imibenconazole, ipconazole, metconazole, myclobutanil, penconazole, propiconazole, prothioconazole, simeconazole, triadimefon, triadimenol, tebuconazole, tetraconazole, triticonazole, prochloraz, pefurazoate, imazalil, triflumizole, cyazofamid, benomyl, carbendazim, thia-bendazole, fuberidazole, ethaboxam, etridiazole and hymexazole, azaconazole, diniconazole-M, oxpoconazol, paclobutrazol, uniconazol, 1-(4-chloro-phenyl)-2-([1,2,4]triazol-1-yl)-cycloheptanol and imazalilsulfphate; B2) strobilurins, including azoxystrobin, dimoxystrobin, enestroburin, fluoxastrobin, kresoxim-methyl, methominostrobin, orysastrobin, picoxystrobin, pyraclostrobin, trifloxystrobin, enestroburin, methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate and methyl 2-(ortho-(2,5-dimethylphenyloxymethylene)-phenyl)-3-methoxyacrylate, 2-(2-(6-(3-chloro-2-methyl-phenoxy)-5-fluoro-pyrimidin-4-yloxy)-phenyl)-2-methoxyimino-N-methyl-acetamide and 3-methoxy-2-(2-(N-(4-methoxy-phenyl)-cyclopropanecarboximidoylsulfanylmethyl)-phenyl)-acrylic acid methyl ester; B3) carboxamides, including carboxin, benalaxyl, benalaxyl-M, fenhexamid, flutolanil, furametpyr, mepronil, metalaxyl, mefenoxam, ofurace, oxadixyl, oxycarboxin, penthiopyrad, isopyrazam, thifluzamide, tiadinil, 3,4-dichloro-N-(2-cyanophenyl)isothiazole-5-carboxamide, dimethomorph, flumorph, flumetover, fluopicolide (picobenzamid), zoxamide, carpropamid, diclocymet, mandipropamid, N-(2-(4-[3-(4-chlorophenyl)prop-2-ynyloxy]-3-methoxyphenyl)ethyl)-2-methanesulfonyl-amino-3-methylbutyramide, N-(2-(4-[3-(4-chloro-phenyl)prop-2-ynyloxy]-3-methoxy-phenyl)ethyl)-2-ethanesulfonylamino-3-methylbutyramide, methyl 3-(4-chlorophenyl)-3-(2-isopropoxycarbonyl-amino-3-methyl-butyrylamino)propionate, N-(4′-bromobiphenyl-2-yl)-4-difluoromethyl\hat{ }-methylthiazole-6-carboxamide, N-(4′-trifluoromethyl-biphenyl-2-yl)-4-difluoromethyl-2-methylthiazole-5-carboxamide, N-(4′-chloro-3′-fluorobiphenyl-2-yl)-4-difluoromethyl-2-methyl-thiazole-5-carboxamide, N-(3\4′-dichloro-4-fluorobiphenyl-2-yl)-3-difluoro-methyl-1-methyl-pyrazole-4-carboxamide, N-(3′,4′-dichloro-5-fluorobiphenyl-2-yl)-3-difluoromethyl-1-methylpyrazole-4-carboxamide, N-(2-cyano-phenyl)-3,4-dichloroisothiazole-5-carboxamide, 2-amino-4-methyl-thiazole-5-carboxanilide, 2-chloro-N-(1,1,3-trimethyl-indan-4-yl)-nicotinamide, N-(2-(1,3-dimethylbutyl)-phenyl)-1,3-dimethyl-5-fluoro-1H-pyrazole-4-carboxamide, N-(4′-chloro-3′,5-difluoro-biphenyl-2-yl)-3-difluoromethyl-1-methyl-1H-pyrazole-4-carboxamide, N-(4′-chloro-3′,5-difluoro-biphenyl-2-yl)-3-trifluoromethyl-1-methyl-1H-pyrazole-4-carboxamide, N-(3′,4′-dichloro-5-fluoro-biphenyl-2-yl)-3-trifluoromethyl-1-methyl-1H-pyrazole-4-carboxamide, N-(3′,5-difluoro-4′-methyl-biphenyl-2-yl)-3-difluoromethyl-1-methyl-1H-pyrazole-4-carboxamide, N-(3′,5-difluoro-4′-methyl-biphenyl-2-yl)-3-trifluoromethyl-1-methyl-1H-pyrazole-4-carboxamide, N-(cis-2-bicyclopropyl-2-yl-phenyl)-3-difluoromethyl-1-methyl-1H-pyrazole-4-carboxamide, N-(trans-2-bicyclopropyl-2-yl-phenyl)-3-difluoro-methyl-1-methyl-1H-pyrazole-4-carboxamide, fluopyram, N-(3-ethyl-3,5-5-trimethyl-cyclohexyl)-3-formylamino-2-hydroxy-benzamide, oxytetracyclin, silthiofam, N-(6-methoxy-pyridin-3-yl) cyclopropanecarboxamide, 2-iodo-N-phenyl-benzamide, N-(2-bicyclo-propyl-2-yl-phenyl)-3-difluormethyl-1-methylpyrazol-4-ylcarboxamide, N-(3′,4′,5′-trifluorobiphenyl-2-yl)-1,3-dimethylpyrazol-4-ylcarboxamide, N-(3′,4′,5′-trifluorobiphenyl-2-yl)-1,3-dimethyl-5-fluoropyrazol-4-yl-carboxamide, N-(3′,4′,5′-trifluorobiphenyl-2-yl)-5-chloro-1,3-dimethyl-pyrazol-4-ylcarboxamide, N-(3′,4′,5′-trifluorobiphenyl-2-yl)-3-fluoromethyl-1-methylpyrazol-4-ylcarboxamide, N-(3′,4′,5′-trifluorobiphenyl-2-yl)-3-(chlorofluoromethyl)-1-methylpyrazol-4-ylcarboxamide, N-(3′,4′,5′-trifluorobiphenyl-2-yl)-3-difluoromethyl-1-methylpyrazol-4-ylcarboxamide, N-(3′,4′,5′-trifluorobiphenyl-2-yl)-3-difluoromethyl-5-fluoro-1-methylpyrazol-4-ylcarboxamide, N-(3′,4′,5′-trifluorobiphenyl-2-yl)-5-chloro-3-difluoromethyl-1-methylpyrazol-4-ylcarboxamide, N-(3′, 4′, 5′-trifluorobiphenyl-2-yl)-3-(chlorodifluoromethyl)-1-methylpyrazol-4-ylcarboxamide, N-(3′,4′,5′-trifluorobiphenyl-2-yl)-1-methyl-3-trifluoromethylpyrazol-4-ylcarboxamide, N-(3′,4′,5′-trifluorobiphenyl-2-yl)-5-fluoro-1-methyl-3-trifluoromethylpyrazol-4-ylcarboxamide, N-(3′,4′,5′-trifluorobiphenyl-2-yl)-5-chloro-1-methyl-3-trifluoromethylpyrazol-4-ylcarboxamide, N-(2′,4′,5′-trifluorobiphenyl-2-yl)-1,3-dimethylpyrazol-4-ylcarboxamide, N-(2′,4′,5′-trifluorobiphenyl-2-yl)-1,3-dimethyl-5-fluoropyrazol-4-ylcarboxamide, N-(2′,4′,5′-trifluorobiphenyl-2-yl)-5-chloro-1,3-dimethylpyrazol-4-ylcarboxamide, N-(2′,4′,5′-trifluorobiphenyl-2-yl)-3-fluoromethyl-1-methylpyrazol-4-ylcarboxamide, N-(2′,4′,5′-trifluorobiphenyl-2-yl)-3-(chlorofluoromethyl)-1-methylpyrazol-4-ylcarboxamide, N-(2′,4′,5′-trifluorobiphenyl-2-yl)-3-difluoromethyl-1-methylpyrazol-4-ylcarboxamide, N-(2′,4′,5′-trifluorobiphenyl-2-yl)-3-difluoromethyl-5-fluoro-1-methylpyrazol-4-ylcarboxamide, N-(2′,4′,5′-trifluorobiphenyl-2-yl)-5-chloro-3-difluoromethyl-1-methylpyrazol-4-ylcarboxamide, N-(2′,4′,5′-trifluorobiphenyl-2-yl)-3-(chlorodifluoromethyl)-1-methylpyrazol-4-ylcarboxamide, N-(2′,4′,5′-trifluorobiphenyl-2-yl)-1-methyl-3-trifluoromethylpyrazol-4-ylcarboxamide, N-(2′,4′,5′-trifluorobiphenyl-2-yl)-5-fluoro-1-methyl-3-trifluoromethylpyrazol-4-ylcarboxamide, N-(2′,4′,5′-trifluorobiphenyl-2-yl)-5-chloro-1-methyl-3-trifluoromethylpyrazol-4-ylcarboxamide, N-(3′,4′-dichloro-3-fluorobiphenyl-2-yl)-1-methyl-3-trifluoromethyl-1H-pyrazole-4-carboxamide, N-(3′,4′-dichloro-3-fluorobiphenyl-2-yl)-1-methyl-3-difluoromethyl-1H-pyrazole-4-carboxamide, N-(3′,4′-difluoro-3-fluorobiphenyl-2-yl)-1-methyl-3-trifluoromethyl-1H-pyrazole-4-carboxamide, N-(3′,4′-difluoro-3-fluorobiphenyl-2-yl)-1-methyl-S-difluoromethyl-1H-pyrazole-4-carboxamide, N-(3′-chloro-4′-fluoro-3-fluorobiphenyl-2-yl)-1-methyl-3-difluoromethyl-1H-pyrazole-4-carboxamide, N-(3′,4′-dichloro-4-fluorobiphenyl-2-yl)-1-methyl-3-trifluoromethyl-1H-pyrazole-4-carboxamide, N-(3′,4′-difluoro-4-fluorobiphenyl-2-yl)-1-methyl-S-trifluoromethyl-1H-pyrazole-4-carboxamide, N-(3′,4′-dichloro-4-fluorobiphenyl-2-yl)-1-methyl-3-difluoromethyl-1H-pyrazole-4-carboxamide, N-(3′,4′-difluoro-4-fluorobiphenyl-2-yl)-1-methyl-3-difluoromethyl-1H-pyrazole-4-carboxamide, N-(3′-chloro-4′-fluoro-4-fluorobiphenyl-2-yl)-1-methyl-S-difluoromethyl-1H-pyrazole-4-carboxamide, N-(3′,4′-dichloro-5-fluorobiphenyl-2-yl)-1-methyl-3-trifluoromethyl-1H-pyrazole-4-carboxamide, N-(3′,4′-difluoro-5-fluorobiphenyl-2-yl)-1-methyl-3-trifluoromethyl-1H-pyrazole-4-carboxamide, N-(3′,4′-dichloro-5-fluorobiphenyl-2-yl)-1-methyl-S-difluoromethyl-1H-pyrazole-carboxamide, N-(3′,4′-difluoro-5-fluorobiphenyl-2-yl)-1-methyl-3-difluoromethyl-1H-pyrazole-4-carboxamide, N-(3′,4′-dichloro-5-fluorobiphenyl-2-yl)-1,3-dimethyl-1H-pyrazole-4-carboxamide, N-(3′-chloro-4′-fluoro-5-fluorobiphenyl-2-yl)-1-methyl-3-difluoromethyl-1H-pyrazole-4-carboxamide, N-(4′-fluoro-4-fluorobiphenyl-2-yl)-1-methyl-3-trifluoromethyl-1H-pyrazole-4-carboxamide, N-(4′-fluoro-5-fluorobiphenyl-2-yl)-1-methyl-3-trifluoromethyl-1H-pyrazole-4-carboxamide, N-(4′-chloro-5-fluorobiphenyl-2-yl)-1-methyl-3-trifluoromethyl-1H-pyrazole-4-carboxamide, N-(4′-methyl-5-fluorobiphenyl-2-yl)-1-methyl-3-trifluoromethyl-1H-pyrazole-4-carboxamide, N-(4′-fluoro-5-fluorobiphenyl-2-yl)-1,3-dimethyl-1H-pyrazole-4-carboxamide, N-(4′-chloro-5-fluorobiphenyl-2-yl)-1,3-dimethyl-1H-pyrazole-4-carboxamide, N-(4′-methyl-5-fluorobiphenyl-2-yl)-1,3-dimethyl-1H-pyrazole-4-carboxamide, N-(4′-fluoro-6-fluorobiphenyl-2-yl)-1-methyl-3-trifluoromethyl-1H-pyrazole-4-carboxamide, N-(4′-chloro-6-fluorobiphenyl-2-yl)-1-methyl-3-trifluoromethyl-1H-pyrazole-4-carboxamide, N-[2-(1,1,2,3,3,3-hexafluoropropoxy)-phenyl]-3-difluoromethyl-1-methyl-1H-pyrazole-4-carboxamide, N-[4′-(trifluoromethylthio)-biphenyl-2-yl]-3-difluoromethyl-1-methyl-1H-pyrazole-4-carboxamide and N-[4′-(trifluoromethylthio)-biphenyl-2-yl]-1-methyl-3-trifluoromethyl-1-methyl-1H-pyrazole-4-carboxamide; B4) heterocyclic compounds, including fluazinam, pyrifenox, bupirimate, cyprodinil, fenarimol, ferimzone, mepanipyrim, nuarimol, pyrimethanil, triforine, fenpiclonil, fludioxonil, aldimorph, dodemorph, fenpropimorph, tridemorph, fenpropidin, iprodione, procymidone, vinclozolin, famoxadone, fenamidone, octhilinone, proben-azole, 5-chloro-7-(4-methyl-piperidin-1-yl)-6-(2,4,6-trifluorophenyl)-[1,2,4]triazolo[1,5-a]pyrimidine, anilazine, diclomezine, pyroquilon, proquinazid, tricyclazole, 2-butoxy-6-iodo-3-propylchromen-4-one, acibenzolar-S-methyl, captafol, captan, dazomet, folpet, fenoxanil, quinoxyfen, N,N-dimethyl-3-(3-bromo-6-fluoro-2-methylindole-1-sulfonyl)-[1,2,4]triazole-1-sulfonamide, 5-ethyl-6-octyl-[1,2,4]triazolo[1,5-a]pyrimidin-2,7-diamine, 2,3,5,6-tetrachloro-4-methanesulfonyl-pyridine, 3,4,5-trichloro-pyridine-2,6-di-carbonitrile, N-(1-(5-bromo-3-chloro-pyridin-2-yl)-ethyl)-2,4-dichloro-nicotinamide, N-((5-bromo-3-chloro pyridin-2-yl)-methyl)-2,4-dichloro-nicotinamide, diflumetorim, nitrapyrin, dodemorphacetate, fluoroimid, blasticidin-S, chinomethionat, debacarb, difenzoquat, difenzoquat-methylsulphat, oxolinic acid and piperalin; B5) carbamates, including maneb, metam, methasulphocarb, metiram, ferbam, propineb, thiram, zineb, ziram, diethofencarb, iprovalicarb, benthiavalicarb, propamocarb, propamocarb hydrochlorid, 4-fluorophenyl N-(1-(1-(4-cyanophenyl)-ethanesulfonyl)but-2-yl)carbamate, methyl 3-(4-chloro-phenyl)-3-(2-isopropoxycarbonylamino-3-methyl-butyrylamino)propanoate; or B6) other fungicides, including guanidine, dodine, dodine free base, iminoctadine, guazatine, antibiotics: kasugamycin, oxytetracyclin and its salts, streptomycin, polyoxin, validamycin A, nitrophenyl derivatives: binapacryl, dinocap, dinobuton, sulfur-containing heterocyclyl compounds: dithianon, isoprothiolane, organometallic compounds: fentin salts, organophosphorus compounds: edifenphos, iprobenfos, fosetyl, fosetyl-aluminum, phosphorous acid and its salts, pyrazophos, tolclofos-methyl, organochlorine compounds: dichlofluanid, flusulfamide, hexachloro-benzene, phthalide, pencycuron, quintozene, thiophanate, thiophanate-methyl, tolylfluanid, others: cyflufenamid, dimethirimol, ethirimol, furalaxyl, metrafenone and spiroxamine, guazatine-acetate, iminoc-tadine-triacetate, iminoctadine-tris(albesilate), kasugamycin hydrochloride hydrate, dichlorophen, pentachlorophenol and its salts, N-(4-chloro-2-nitro-phenyl)-N-ethyl-4-methyl-benzenesulfonamide, dicloran, nitrothal-isopropyl, tecnazen, biphenyl, bronopol, diphenylamine, mildiomycin, oxincopper, prohexadione calcium, N-(cyclopropylmethoxyimino-(6-difluoromethoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluormethyl-4-(3-trimethylsilanyl-propoxy)-phenyl)-N-ethyl-N-methylformamidine and N′-(5-difluormethyl-2-methyl-4-(3-trimethylsilanyl-propoxy)-phenyl)-N-ethyl-N-methyl formamidine.

Herbicides: C1) acetyl-CoA carboxylase inhibitors (ACC), for example cyclohexenone oxime ethers, such as alloxydim, clethodim, cloproxydim, cycloxydim, sethoxydim, tralkoxydim, butroxydim, clefoxydim or tepraloxydim; phenoxyphenoxypropionic esters, such as clodinafop-propargyl, cyhalofop-butyl, diclofop-methyl, fenoxaprop-ethyl, fenoxaprop-P-ethyl, fenthiapropethyl, fluazifop-butyl, fluazifop-P-butyl, haloxyfop-ethoxyethyl, haloxyfop-methyl, haloxyfop-P-methyl, isoxapyrifop, propaquizafop, quizalofop-ethyl, quizalofop-P-ethyl or quizalofop-tefuryl; or arylaminopropionic acids, such as flamprop-methyl or flamprop-isopropyl; C2 acetolactate synthase inhibitors (ALS), for example imidazolinones, such as imazapyr, imazaquin, imazamethabenz-methyl (imazame), imazamox, imazapic or imazethapyr; pyrimidyl ethers, such as pyrithiobac-acid, pyrithiobac-sodium, bispyribac-sodium. KIH-6127 or pyribenzoxym; sulfonamides, such as florasulam, flumetsulam or metosulam; or sulfonylureas, such as amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, halosulfuron-methyl, imazosulfuron, metsulfuron-methyl, nicosulfuron, primisulfuron-methyl, prosulfuron, pyrazosulfuron-ethyl, rimsulfuron, sulfometuron-methyl, thifensulfuron-methyl, triasulfuron, tribenuron-methyl, triflusulfuron-methyl, tritosulfuron, sulfosulfuron, foramsulfuron or iodosulfuron; C3) amides, for example allidochlor (CDAA), benzoylprop-ethyl, bromobutide, chiorthiamid. diphenamid, etobenzanidibenzchlomet), fluthiamide, fosamin or monalide; C4) auxin herbicides, for example pyridinecarboxylic acids, such as clopyralid or picloram; or 2,4-D or benazolin; C5) auxin transport inhibitors, for example naptalame or diflufenzopyr; C6) carotenoid biosynthesis inhibitors, for example benzofenap, clomazone (dimethazone), diflufenican, fluorochloridone, fluridone, pyrazolynate, pyrazoxyfen, isoxaflutole, isoxachlortole, mesotrione, sulcotrione (chlormesulone), ketospiradox, flurtamone, norflurazon or amitrol; C7) enolpyruvylshikimate-3-phosphate synthase inhibitors (EPSPS), for example glyphosate or sulfosate; C8) glutamine synthetase inhibitors, for example bilanafos (bialaphos) or glufosinate-ammonium; C9) lipid biosynthesis inhibitors, for example anilides, such as anilofos or mefenacet; chloroacetanilides, such as dimethenamid, S-dimethenamid, acetochlor, alachlor, butachlor, butenachlor, diethatyl-ethyl, dimethachlor, metazachlor, metolachlor, S-metolachlor, pretilachlor, propachlor, prynachlor, terbuchlor, thenylchlor or xylachlor; thioureas, such as butylate, cycloate, di-allate, dimepiperate, EPTC. esprocarb, molinate, pebulate, prosulfocarb, thiobencarb (benthiocarb), tri-allate or vemolate; or benfuresate or perfluidone; C10) mitosis inhibitors, for example carbamates, such as asulam, carbetamid, chlorpropham, orbencarb, pronamid (propyzamid), propham or tiocarbazil; dinitroanilines, such as benefin, butralin, dinitramin, ethalfluralin, fluchloralin, oryzalin, pendimethalin, prodiamine; pyridines, such as dithiopyr or thiazopyr; or butamifos, chlorthal-dimethyl (DCPA) or maleic hydrazide; C11) protoporphyrinogen IX oxidase inhibitors, for example diphenyl ethers, such as acifluorfen, acifluorfen-sodium, aclonifen, bifenox, chlomitrofen (CNP), ethoxyfen, fluorodifen, fluoroglycofen-ethyl, fomesafen, furyloxyfen, lactofen, nitrofen, nitrofluorfen or oxyfluorfen; oxadiazoles, such as oxadiargyl or oxadiazon; cyclic imides, such as azafenidin, butafenacil, carfentrazone-ethyl, cinidon-ethyl, flumiclorac-pentyl, flumioxazin, flumipropyn, flupropacil, fluthiacet-methyl, sulfentrazone or thidiazimin; or pyrazoles, such as ET-751.JV 485 or nipyraclofen; C12) photosynthesis inhibitors, for example propanil, pyridate or pyridafol; benzothiadiazinones, such as bentazone; dinitrophenols, for example bromofenoxim, dinoseb, dinoseb-acetate, dinoterb or DNOC; dipyridylenes, such as cyperquat-chloride, difenzoquat-methylsulfate, diquat or paraquat-dichloride; ureas, such as chlorbromuron, chlorotoluron, difenoxuron, dimefuron, diuron, ethidimuron, fenuron, fluometuron, isoproturon, isouron, linuron, methabenzthiazuron, methazole, metobenzuron, metoxuron, monolinuron, neburon, siduron or tebuthiuron; phenols, such as ioxynil; chloridazon; triazines, such as ametryn, atrazine, cyanazine, desmein, dimethamethryn, hexazinone, prometon, prometryn, propazine, simazine, simetryn, terbumeton, terbutryn, terbutylazine or trietazine; triazinones, such as metamitron or metribuzin; uracils, such as bromacil, lenacil or terbacil; or biscarbamates, such as desmedipham or phenmedipham; C13) synergists, for example oxiranes, such as tridiphane; C14) CIS cell wall synthesis inhibitors, for example isoxaben or dichlobenil; C15) various other herbicides, for example dichloropropionic acids, such as dalapon; dihydrobenzofurans, such as ethofumesate; phenylacetic acids, such as chlorfenac (fenac); or aziprotryn, barban, bensulide, benzthiazuron, benzofluor, buminafos, buthidazole, buturon, cafenstrole, chlorbufam, chlorfenprop-methyl, chloroxuron, cinmethylin, cumyluron, cycluron, cyprazine, cyprazole, dibenzyluron, dipropetryn, dymron, eglinazin-ethyl, endothall, ethiozin, flucabazone, fluorbentranil, flupoxam, isocarbamid, isopropalin, karbutilate, mefluidide, monuron, napropamide, napropanilide, nitralin, oxaciclomefone, phenisopham, piperophos, procyazine, profluralin, pyributicarb, secbumeton, sulfallate (CDEC), terbucarb, triaziflam, triazofenamid or trimeturon; or their environmentally compatible salts.

Nematicides or bionematicides: Benomyl, cloethocarb, aldoxycarb, tirpate, diamidafos, fenamiphos, cadusafos, dichlofenthion, ethoprophos, fensulfothion, fosthiazate, heterophos, isamidofof, isazofos, phosphocarb, thionazin, imicyafos, mecarphon, acetoprole, benclothiaz, chloropicrin, dazomet, fluensulfone, 1,3-dichloropropene (telone), dimethyl disulfide, metam sodium, metam potassium, metam salt (all MITC generators), methyl bromide, biological soil amendments (e.g., mustard seeds, mustard seed extracts), steam fumigation of soil, allyl isothiocyanate (AITC), dimethyl sulfate, furfual (aldehyde).

Suitable plant growth regulators of the present invention include the following: Plant Growth Regulators: D1) Antiauxins, such as clofibric acid, 2,3,5-tri-iodobenzoic acid; D2) Auxins such as 4-CPA, 2,4-D, 2,4-DB, 2,4-DEP, dichlorprop, fenoprop, IAA, IBA, naphthaleneacetamide, a-naphthaleneacetic acids, 1-naphthol, naphthoxyacetic acids, potassium naphthenate, sodium naphthenate, 2,4,5-T; D3) cytokinins, such as 2iP, benzyladenine, 4-hydroxyphenethyl alcohol, kinetin, zeatin; D4) defoliants, such as calcium cyanamide, dimethipin, endothal, ethephon, merphos, metoxuron, pentachlorophenol, thidiazuron, tribufos; D5) ethylene inhibitors, such as aviglycine, 1-methylcyclopropene; D6) ethylene releasers, such as ACC, etacelasil, ethephon, glyoxime; D7) gametocides, such as fenridazon, maleic hydrazide; D8) gibberellins, such as gibberellins, gibberellic acid; D9) growth inhibitors, such as abscisic acid, ancymidol, butralin, carbaryl, chlorphonium, chlorpropham, dikegulac, flumetralin, fluoridamid, fosamine, glyphosine, isopyrimol, jasmonic acid, maleic hydrazide, mepiquat, piproctanyl, prohydrojasmon, propham, tiaojiean, 2,3,5-tri-iodobenzoic acid; D10) morphactins, such as chlorfluren, chlorflurenol, dichlorflurenol, flurenol; D11) growth retardants, such as chlormequat, daminozide, flurprimidol, mefluidide, paclobutrazol, tetcyclacis, uniconazole; D12) growth stimulators, such as brassinolide, brassinolide-ethyl, DCPTA, forchlorfenuron, hymexazol, prosuler, triacontanol; D13) unclassified plant growth regulators, such as bachmedesh, benzofluor, buminafos, carvone, choline chloride, ciobutide, clofencet, cyanamide, cyclanilide, cycloheximide, cyprosulfamide, epocholeone, ethychlozate, ethylene, fuphenthiourea, furalane, heptopargil, holosulf, inabenfide, karetazan, lead arsenate, methasulfocarb, prohexadione, pydanon, sintofen, triapenthenol, trinexapac.

### EXAMPLES

The examples serve only to illustrate the embodiments described and should not be interpreted as limiting since further modifications of the disclosed embodiments will be apparent to those of ordinary skill in the art. All such modifications are deemed to be within the scope of the invention as defined in the claims. It will be obvious to those of ordinary skill in the art that variations in the preferred and described formulations and methods may be used and that it is intended that the claimed invention may be practiced otherwise than as specifically described herein. Accordingly, this invention includes all modifications encompassed within the spirit and scope of the invention as defined by the claims that follow.

Further, exemplary ranges and dimensions are provided herein merely for purposes of illustration and not limitation. Although individual features of one embodiment of the disclosed subject matter may be discussed herein of the one embodiment and not in other embodiments, it should be apparent that individual features of one embodiment may be combined with one or more features of another embodiment or features from a plurality of embodiments.

### Example 1: Process to Prepare Clomazone EC Compositions

The following Clomazone EC Compositions were made using the process discussed herein. The clomazone compositions were made into clomazone formulation spray mixtures by diluting with water and then were applied to soil of a granular nature (obtained by sieving). This soil was then placed in a glass column where air passed between the soil particles. As the clomazone volatilized off the soil particles it was carried out of the soil by the air stream, and was absorbed by a foam plug at the end of the column. The clomazone was extracted from the foam with methanol following the collection period, and the extract was quantitated for the captured clomazone using an immunoassay method.

Clomazone EC Compositions

Test Composition 1
Pethoxamid - Clomazone EC

| Ingredient | Wt % |
|---|---|
| PXA (Pethoxamid) | 48 |
| CLZ (Clomazone) | 24 |
| Aromatic 150ND (Organic Solvent) | 84.7 |
| Rhodacal ® 60 B/E (Surfactant) | 4.74 |
| Soprophor ® CY8 (Surfactant) | 9.6 |
| Gamma Butyrolactone (Solvent) | 16.9 |
| Benzoic Acid (Anti-crystallization inhibitor) | 12.06 |

Test Composition 2
Bromoxynil - Clomazone EC

| Ingredient | Wt % |
|---|---|
| Bromoxynil Octanoate | 20 |
| CLZ (Clomazone) | 5 |
| Aromatic 200ND (Organic Solvent) | 44.8 |
| Hallcomid M8-10 (Disubstituted Amide) | 15.6 |
| Tergitol ® XD (Emulsifyer) | 3.2 |
| Rhodacal ® 70B (Surfactant) | 6.71 |
| Rhodasurf ® BC 840 (Surfactant) | 4.55 |

Test Composition 3
Trifluralin - Clomazone EC

| Ingredient | Wt % |
|---|---|
| Trifluralin | 34 |
| Clomazone | 27 |
| Aromatic 200 (Organic Solvent) | 33 |
| Niagara 1 (Emulsifer blend) | 3 |
| Tergitol ® XD (Emulsifyer) | 3 |
| Niagara 2 (Emulsifer blend) | 2 |

Test Composition 4
Metazachlor - Clomazone EC

| Ingredient | Wt % |
|---|---|
| Metazachlor | 12.8 |
| CLZ (Clomazone) | 1.84 |
| Aromatic 100 (Organic Solvent) | 51.98 |
| Hallcomid M8-10 (Solvent) | 17.34 |
| Antarox ® B848 (Emulsifyer) | 3.59 |
| Rhodacal ® 70/B (Surfactant) | 7.47 |
| Rhodasurf ® BC-840 (Surfactant) | 4.98 |

Test Composition 5
Metazachlor - Napropramide - Clomazone EC

| Ingredient | Wt % |
|---|---|
| Metazachlor | 14.2 |
| Napropamide | 14.2 |
| Clomazone | 2.25 |
| Aromatic 100 (Organic Solvent) | 56.3 |
| Antarox ® B848 (Emulsifyer) | 2.91 |
| Rhodacal ® 70/B (Surfactant) | 6.07 |
| Rhodasurf ® BC 840 (Surfactant) | 4.04 |

Test Composition 6
Metazachlor - Napropramide - Clomazone EC

| Ingredient | Wt % |
|---|---|
| Metazachlor | 14.2 |
| Napropamide | 14.2 |
| HP CLZ Technical (Clomazone) | 2.25 |
| Aromatic 100 (Organic Solvent) | 42.24 |
| Hallcomid M8-10 (Solvent) | 14.1 |
| Antarox ® B848 (Emulsifyer) | 2.9 |
| Rhodacal ® 70/B (Surfactant) | 6.07 |
| Rhodasurf ® BC 840 (Surfactant) | 4.04 |

Test Composition 7
Sulfentrazone - Clomazone EC

| Ingredient | Wt % |
|---|---|
| Sulfentrazone | 20 |
| Clomazone | 5 |
| Atsol 200ND (Solvent) | 44.8 |
| Hallcomid M8-10 (Solvent) | 15.6 |
| Propylene carbonate (Solvent) | 3.2 |
| Antarox ® B848 (Surfactant) | 6.71 |
| Toximul ® 3483 (Surfactant) | 4.55 |

To make the above listed compositions, first the solvent was charged to a flask equipped with mechanical agitation. Next, the solid surfactants were added, followed by the liquid surfactants in the respective compositions. Next, the active ingredients were added to the flask, and the resultant composition was stirred until all of the solid components were dissolved.

### Example 2: General Process Used to Test the Volatility Control of the Resultant Compositions

### Soil Treatment

The sieved soil was spread on a deep tray, to have a fairly uniform layer that was about 2-mm thick. The clomazone formulation was applied by spraying this surface at a rate of 1.0 kg clomazone using an overhead track sprayer calibrated to deliver 20 gallons of water per acre (187 L/ha) Immediately after treatment, the soil was transferred to a glass jar, where it was mixed by briefly rolling and shaking the jar. The soil was kept in the jar for a short period (less than one hour) until it was placed in the columns

### Volatility Apparatus

Volatility was determined in an apparatus where the soil was held in glass chromatography columns with air entering from a manifold through the bottom of each tube. The manifold divided the airflow and equalized the pressure on the flow through each individual column. Nine chromatography columns were connected to each manifold, taking care to make sure the length of tubing and other restrictions to the flow were equal for each column. The columns were glass chromatography columns that contained a coarse frit at the bottom. The frit kept the soil in the column and dispersed the air stream that was coming in through the bottom of the column. The upward airflow provided a slight lift on the soil particles and thus counteracted any tendency towards clogging of the airflow, especially against the frit. The frit was the main source of resistance to air flow in the system. Thus, the flow of air through each column was measured under constant pressure, when the columns were empty. Columns with equivalent flow rates (i.e., equivalent frit resistance) were matched up to connect to each manifold. Each manifold and its attached nine columns constituted one replicate of the experimental design. There were four equivalent sets of manifolds and columns, each set contained in its own rack.

### Column Preparation

Treated soil was generally placed in each column, enough to fill about ⅔ of the column volume. This amount allowed the sample of treated soil to be split between four replicates. Polyurethane foam plugs designed to fit inside a tube, were inserted into the top of the chromatography column. This left a gap between the top of the soil and the foam plug. These plugs have a large surface area and are very effective at quantitatively trapping organic molecules such as clomazone. In preliminary trials when two plugs were used in series to trap the clomazone, essentially all the clomazone was trapped in the first plug, so only one plug was used in each column.

To fill the columns, soil was poured in through a protective paper sleeve that prevented the treated soil from contaminating the sides of the column. This prevented contamination of the sample collection plug. Air flow was started as soon after soil treatment as the columns could be set up; generally, this took about one hour.

Sample collection was conducted in the dark in a constant temperature growth chamber set at 25° C. By bubbling the air through water, using a fitted-glass gas dispersion tube, the air flowing into the columns was humidified. This increased air humidity and decreased the rate of soil drying. Once airflow began the flow through each column was measured to assure proper system function and to confirm that the variation between columns within a replicate was small. The airflow was measured again just before sample collection was terminated, to make sure there had not been any major changes. Termination of the airflow after 18 hours ended the collection of clomazone.

Extraction of Sample

The sample generally collected on the foam plug was extracted from the plug with methanol in order to quantitate the amount collected. The plug was removed from the column and placed in a 20-cc plastic syringe, in order to extract it. Methanol was drawn up in the syringe, and through the plug, three times so as to thoroughly extract the clomazone from the foam. The total amount of clomazone captured was calculated as the product of the clomazone concentration in the methanol multiplied by the original volume of methanol used for the extraction.

### Sample Preparation and Analysis

Samples were analyzed using antibodies specifically recognizing the clomazone molecule in a HPLC MS and standardized immunoassay. The immunoassay methodology is as described in a publication by Dargar et al. (Dargar, R. V., Tymonko, J. M., and VanDerWerf, P., “Clomazone Measurement by Enzyme-Linked Immunosorbent Assay,” J. Agric. Food Chem. Vol. 39, 1991, pp. 813-819.). This reference describes all the solutions used in this assay. It also describes how the antibodies were generated.

### Experimental Design

Each run of the trial to collect volatility samples contained nine treatments and four replicates. One of the treatments was an application of the 4EC formulation against which all the other treatments were compared. One of the other treatments in the trials was sample of clomazone 3CS. On a replicate basis the amount of clomazone captured for each treatment was normalized against the 4EC formulation standard to give a percent value. The mean of these normalized values across the replicates appears in the data tables as the volatility (as a percentage of the 4EC formulation).

### Clomazone Release in Spray Tank

To examine potential changes in volatility after the 3CS compositions were diluted in water, the spray mixes were made up with the clomazone compositions discussed in Example 1 for use in applications applied at 10 or 20 gal/acre. The spray mixes were aged before being assayed. The 4EC spray mix was made up only at zero time and was not aged. All samples were assayed for clomazone content in the aqueous phase, and the samples aged for longer times were assayed for clomazone volatility.

The spray mixes were made up in the morning on different days so that after the prescribed storage time, the samples were all ready for analysis on the same afternoon. At that time, these spray mixes were split and used either to establish a volatility trial, or the microcapsules were removed from the mix by filtration and the remaining aqueous phase was sent for weight percent clomazone analysis. For the zero time sample the separation of the capsules from the aqueous phase took place within about 20 to 30 min of preparing the mix, the volatility trial was started within three hours after the spray mix preparation. Because comparison to the 4EC formulation sample and the zero time sample are critical for the comparisons to all the other treatments, these two treatments were duplicated in the trial design.

The volatility control of clomazone when mixed with metazachlor, Test Composition 4, is determined to be 45% less than Command® 4EC (the control standard). When mixed with a blend of metazachlor and napropamide (Test Compositions 5 and 6) clomazone is significantly less volatile than the standard Command® 4EC.

In addition to the to the compositions listed in Example 1, the volatility control of the following compositions was tested, and the results are provided in Tables 1, 2, and 3:

TABLE 1

| Test Composition | Volatility Control % |
|---|---|
| 1 | 0.2 |
| 2 | −13.1 |
| 3 | 0.3 |
| 4 | 45.2 |
| 5 | 49.0 |
| 6 | 46.7 |
| 7 | 0.0 |

TABLE 2

| | Total | % Volatility |
|---|---|---|
| Composition | (μgs) | Control vs. 4EC |
| Command ® 3ME Standard | 23.18 | 88.3 |
| Command ® 4EC Standard | 198.54 | 0.0 |
| Clomazone/Metazachlor/Napropamide EC | 105.81 | 46.7 |

TABLE 3

| | Total | % Volatility |
|---|---|---|
| Composition | (μgs) | Control vs. 4EC |
| Command ® 3ME Standard | 34.45 | 85.3 |
| Command ® 4EC Standard | 234.37 | 0.0 |
| Clomazone/Metazachlor EC | 128.46 | 45.2 |
| Clomazone/Metazachlor/Napropamide EC | 119.53 | 49.0 |

The data indicates that mixtures of metazachlor and clomazone reduce the volatility control of clomazone in an EC composition. An EC composition provides no volatility control. To date, mainly the volatility control has only been achieved by microencapsulation of the clomazone active and entrapment of clomozone in a microcapsule shell. For the first time, the present inventors provide an alternative methodlogy to improve volatility control of clomozone EC compositions. The data provides conclusively that metazachlor reduces clomazone volatility control by a statistically significant amount. Even though the level may not match the volatility control reduction seen in the best microcapsule formulas, an almost 50% improvement is a statistically significant volatility control reduction. The present invention would simplify manufacturing process compared with an encapsulation process, while providing improved volatility control compared with conventional non-encapsulation processes. As seen in the test compositions' volatility control data, mixtures of clomazone with other agriculturally active components can eliminate the need for microencapsulation of clomazone, thereby improving the rate of delivery and/or availability of clomazone to the area of interest. Eliminating the microencapsulation process from a clomazone production process can also yield commercial benefits. These results are unexpected.

In addition to the specific embodiments claimed below, the disclosed subject matter is also directed to other embodiments having any other possible combination of the dependent features claimed below and those disclosed above. For example, in one embodiment, one of ordinary skill in the art can broaden the zone of protection in comparison to what could have been achieved with standard liquid applications. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. A method for reducing the volatility of clomazone in an agricultural composition, comprising combining clomazone and a second active ingredient to form an emulsifiable concentrate in the substantial absence of water, wherein the entire composition is water-free.

2. The method of claim 1, wherein the second active ingredient is selected from the group consisting of: acetochlor; aclonifen; alachlor; ametryn; dimethachlor; dimethanamide; dimethenamid-P; carfentrazone ethyl; ethalfluralin; linuron; metazachlor; napropamide; napropamide-M; metolachlor; S-metolachlor; pendimethalin; propanil agriculturally acceptable esters thereof and mixtures of two or more thereof.

3. The method of claim 2, wherein the second active ingredient is metazachlor.

4. The method of claim 1, wherein the composition optionally includes a third active ingredient.

5. The method of claim 4, wherein the third active ingredient is selected from the group consisting of: acetochlor; aclonifen; alachlo; ametryn; dimethachlor; dimethanamide; dimethenamid-P; carfentrazone ethyl; ethalfluralin; linuron; metazachlor; napropamide; napropamide-M; metolachlor; S-metolachlor; pendimethalin; propanil; butachlor; delachlor; diethatyl; ethachlor; pretilachlor; propachlor; propisochlor; prynachlor; terbuchlor; thenylchlor; xylachlor; Diphenamid; naptalam; pethox-amid; pretilachlor; benzofluor; cambendichlor; chloramben; dicamba; bispyribac; pyrithiobac; mesotrione; sulcotrione; te-furyltrione; tembotrione; benfuresate; asulam; barban; alloxydim; isoxaflutole; dinitramine; dipropalin; pendimethalin; acifluorfen; etnipromid; fluoronitrofen; fomesafen; imazamethabenz; bromobonil; methiozolin; monisouron; pyroxasulfone; topramezone; bromofenoxim; clomeprop; 2-(2,4-dichlorophenoxy)ethanol benzoate (2,4-DEB); et-nipromid; clacyfos; (4-Chlorophenoxy)acetic acid (4-CPA); 2,4-Dichlorophenoxyacetic acid (2,4-D); 4-(2,4-Dichlorophenoxy)butanoic acid (2,4-DB); 4-(3,4-Dichlorophenoxy)butanoic acid (3,4-DB); cloprop; 2-(4-Chlorophenoxy)propanoic acid (4-CPP); dichlorprop; chlora-zifop; clodinafop; clofop; cyhalofop; kuicaoxi; metamifop; propaquizafop; quizalofop; difenzoquat; halosulfuron; fluazolate; brompyrazon; clopyralid; diflufenican; atrazine; chlorazine; cyanazine; cyprazine; trietazine; indaziflam; ametryn; methoprotryne; simetryn; terbutryn; ethiozin; hexazinone; metribuzin; amicarbazone; bencarbazone; carfentrazone; sulfentrazone; thiencarbazone; cloransulam; isoproturon; methiuron; metobromuron; metoxuron; tetrafluron; thidiazuron; amidosulfuron; cyclosulfamuron; ethoxysulfuron; flucetosulfuron; metsulfuron; prosulfuron; thifensulfu-ron; tebuthiuron; acrolein; flurtamone; fluthiacet-methyl; funaihecaoling; agriculturally acceptable esters thereof; and mixtures of two or more thereof, wherein the second active ingredient is different from the third active ingredient.

6. The method of claim 1 further comprising the step of adding at least one surfactant and at least one emulsifier to the composition.

7. The method of claim 6, wherein the second active ingredient is selected from the group consisting of acetochlor, aclonifen, alachlor, ametryn, dimethachlor, dimethanamide, dimethenamid-P, carfentrazone ethyl, ethalfluralin, linuron, metazachlor, napropamide, napropamide-M, metolachlor, S-metolachlor, pendimethalin, propanil, agriculturally acceptable esters thereof and mixtures of two or more thereof.

8. The method of claim 6, wherein the second active ingredient is metazachlor.

9. The method of claim 6, wherein the composition optionally includes a third active ingredient selected from the group consisting of: acetochlor; aclonifen; alachlo; ametryn; dimethachlor; dimethanamide; dimethenamid-P; carfentrazone ethyl; ethalfluralin; linuron; metazachlor; napropamide; napropamide-M; metolachlor; S-metolachlor; pendimethalin; propanil; butachlor; delachlor; diethatyl; ethachlor; pretilachlor; propachlor; propisochlor; prynachlor; terbuchlor; thenylchlor; xylachlor; Diphenamid; naptalam; pethox-amid; pretilachlor; benzofluor; cambendichlor; chloramben; dicamba; bispyribac; pyrithiobac; mesotrione; sulcotrione; te-furyltrione; tembotrione; benfuresate; asulam; barban; alloxydim; isoxaflutole; dinitramine; dipropalin; pendimethalin; acifluorfen; etnipromid; fluoronitrofen; fomesafen; imazamethabenz; bromobonil; methiozolin; monisouron; pyroxasulfone; topramezone; bromofenoxim; clomeprop; 2-(2,4-dichlorophenoxy)ethanol benzoate (2,4-DEB); et-nipromid; clacyfos; (4-Chlorophenoxy)acetic acid (4-CPA); 2,4-Dichlorophenoxyacetic acid (2,4-D); 4-(2,4-Dichlorophenoxy)butanoic acid (2,4-DB); 4-(3,4-Dichlorophenoxy)butanoic acid (3,4-DB); cloprop; 2-(4-Chlorophenoxy)propanoic acid (4-CPP); dichlorprop; chlora-zifop; clodinafop; clofop; cyhalofop; kuicaoxi; metamifop; propaquizafop; quizalofop; difenzoquat; halosulfuron; fluazolate; brompyrazon; clopyralid; diflufenican; atrazine; chlorazine; cyanazine; cyprazine; trietazine; indaziflam; ametryn; methoprotryne; simetryn; terbutryn; ethiozin; hexazinone; metribuzin; amicarbazone; bencarbazone; carfentrazone; sulfentrazone; thiencarbazone; cloransulam; isoproturon; methiuron; metobromuron; metoxuron; tetrafluron; thidiazuron; amidosulfuron; cyclosulfamuron; ethoxysulfuron; flucetosulfuron; metsulfuron; prosulfuron; thifensulfu-ron; tebuthiuron; acrolein; flurtamone; fluthiacet-methyl; funaihecaoling; agriculturally acceptable esters thereof; and mixtures of two or more thereof, wherein the second active ingredient is different from the third active ingredient.

10. A formulation comprising:
a. a water-free composition comprising an emulsifiable concentrate (EC) of clomazone and a second active ingredient; and
b. water;
wherein said formulation is an EW (oil in water) formulation.

11. The formulation of claim 10, wherein the second active ingredient is selected from the group consisting of acetochlor, aclonifen, alachlor, ametryn, dimethachlor, dimethanamide, dimethenamid-P, carfentrazone ethyl, ethalfluralin, linuron, metazachlor, napropamide, napropamide-M, metolachlor, S-metolachlor, pendimethalin, propanil, agriculturally acceptable esters thereof and mixtures of two or more thereof.

12. The formulation of claim 11, wherein the second active ingredient is metazachlor.

13. The formulation of claim 10, wherein the composition optionally includes a third active ingredient.

14. The formulation of claim 13, wherein the third active ingredient is selected from the group consisting of: acetochlor; aclonifen; alachlo; ametryn; dimethachlor; dimethanamide; dimethenamid-P; carfentrazone ethyl; ethalfluralin; linuron; metazachlor; napropamide; napropamide-M; metolachlor; S-metolachlor; pendimethalin; propanil; butachlor; delachlor; diethatyl; ethachlor; pretilachlor; propachlor; propisochlor; prynachlor; terbuchlor; thenylchlor; xylachlor; Diphenamid; naptalam; pethox-amid; pretilachlor; benzofluor; cambendichlor; chloramben; dicamba; bispyribac; pyrithiobac; mesotrione; sulcotrione; te-furyltrione; tembotrione; benfuresate; asulam; barban; alloxydim; isoxaflutole; dinitramine; dipropalin; pendimethalin; acifluorfen; etnipromid; fluoronitrofen; fomesafen; imazamethabenz; bromobonil; methiozolin; monisouron; pyroxasulfone; topramezone; bromofenoxim; clomeprop; 2-(2,4-dichlorophenoxy)ethanol benzoate (2,4-DEB); et-nipromid; clacyfos; (4-Chlorophenoxy)acetic acid (4-CPA); 2,4-Dichlorophenoxyacetic acid (2,4-D); 4-(2,4-Dichlorophenoxy)butanoic acid (2,4-DB); 4-(3,4-Dichlorophenoxy)butanoic acid (3,4-DB); cloprop; 2-(4-Chlorophenoxy)propanoic acid (4-CPP); dichlorprop; chlora-zifop; clodinafop; clofop; cyhalofop; kuicaoxi; metamifop; propaquizafop; quizalofop; difenzoquat; halosulfuron; fluazolate; brompyrazon; clopyralid; diflufenican; atrazine; chlorazine; cyanazine; cyprazine; trietazine; indaziflam; ametryn; methoprotryne; simetryn; terbutryn; ethiozin; hexazinone; metribuzin; amicarbazone; bencarbazone; carfentrazone; sulfentrazone; thiencarbazone; cloransulam; isoproturon; methiuron; metobromuron; metoxuron; tetrafluron; thidiazuron; amidosulfuron; cyclosulfamuron; ethoxysulfuron; flucetosulfuron; metsulfuron; prosulfuron; thifensulfu-ron; tebuthiuron; acrolein; flurtamone; fluthiacet-methyl; funaihecaoling; agriculturally acceptable esters thereof; and mixtures of two or more thereof, wherein the second active ingredient is different from the third active ingredient.

15. (canceled)

16. (canceled)

17. (canceled)

18. (canceled)

19. The method of claim 18, wherein the third active ingredient is selected from the group consisting of: acetochlor; aclonifen; alachlo; ametryn; dimethachlor; dimethanamide; dimethenamid-P; carfentrazone ethyl; ethalfluralin; linuron; metazachlor; napropamide; napropamide-M; metolachlor; S-metolachlor; pendimethalin; propanil; butachlor; delachlor; diethatyl; ethachlor; pretilachlor; propachlor; propisochlor; prynachlor; terbuchlor; thenylchlor; xylachlor; Diphenamid; naptalam; pethox-amid; pretilachlor; benzofluor; cambendichlor; chloramben; dicamba; bispyribac; pyrithiobac; mesotrione; sulcotrione; te-furyltrione; tembotrione; benfuresate; asulam; barban; alloxydim; isoxaflutole; dinitramine; dipropalin; pendimethalin; acifluorfen; etnipromid; fluoronitrofen; fomesafen; imazamethabenz; bromobonil; methiozolin; monisouron; pyroxasulfone; topramezone; bromofenoxim; clomeprop; 2-(2,4-dichlorophenoxy)ethanol benzoate (2,4-DEB); et-nipromid; clacyfos; (4-Chlorophenoxy)acetic acid (4-CPA); 2,4-Dichlorophenoxyacetic acid (2,4-D); 4-(2,4-Dichlorophenoxy)butanoic acid (2,4-DB); 4-(3,4-Dichlorophenoxy)butanoic acid (3,4-DB); cloprop; 2-(4-Chlorophenoxy)propanoic acid (4-CPP); dichlorprop; chlora-zifop; clodinafop; clofop; cyhalofop; kuicaoxi; metamifop; propaquizafop; quizalofop; difenzoquat; halosulfuron; fluazolate; brompyrazon; clopyralid; diflufenican; atrazine; chlorazine; cyanazine; cyprazine; trietazine; indaziflam; ametryn; methoprotryne; simetryn; terbutryn; ethiozin; hexazinone; metribuzin; amicarbazone; bencarbazone; carfentrazone; sulfentrazone; thiencarbazone; cloransulam; isoproturon; methiuron; metobromuron; metoxuron; tetrafluron; thidiazuron; amidosulfuron; cyclosulfamuron; ethoxysulfuron; flucetosulfuron; metsulfuron; prosulfuron; thifensulfu-ron; tebuthiuron; acrolein; flurtamone; fluthiacet-methyl; funaihecaoling; agriculturally acceptable esters thereof; and mixtures of two or more thereof, wherein the second active ingredient is different from the third active ingredient.

20. An agricultural composition consisting essentially of water admixed with a water-free composition comprising an emulsion concentrate of clomazone and a second active ingredient selected from the group consisting of acetochlor, aclonifen, alachlor, ametryn, dimethachlor, dimethanamide, dimethenamid-P, carfentrazone ethyl, ethalfluralin, linuron, metazachlor, napropamide, napropamide-M, metolachlor, S-metolachlor, pendimethalin, propanil, agriculturally acceptable esters thereof and mixtures of two or more thereof.

21. The agricultural composition of claim 20, wherein the second active ingredient is metazachlor.

22. The agricultural composition of claim 20, wherein the water-free composition optionally includes a third active ingredient selected from the group consisting of: acetochlor; aclonifen; alachlo; ametryn; dimethachlor; dimethanamide; dimethenamid-P; carfentrazone ethyl; ethalfluralin; linuron; metazachlor; napropamide; napropamide-M; metolachlor; S-metolachlor; pendimethalin; propanil; butachlor; delachlor; diethatyl; ethachlor; pretilachlor; propachlor; propisochlor; prynachlor; terbuchlor; thenylchlor; xylachlor; Diphenamid; naptalam; pethox-amid; pretilachlor; benzofluor; cambendichlor; chloramben; dicamba; bispyribac; pyrithiobac; mesotrione; sulcotrione; te-furyltrione; tembotrione; benfuresate; asulam; barban; alloxydim; isoxaflutole; dinitramine; dipropalin; pendimethalin; acifluorfen; etnipromid; fluoronitrofen; fomesafen; imazamethabenz; bromobonil; methiozolin; monisouron; pyroxasulfone; topramezone; bromofenoxim; clomeprop; 2-(2,4-dichlorophenoxy)ethanol benzoate (2,4-DEB); et-nipromid; clacyfos; (4-Chlorophenoxy)acetic acid (4-CPA); 2,4-Dichlorophenoxyacetic acid (2,4-D); 4-(2,4-Dichlorophenoxy)butanoic acid (2,4-DB); 4-(3,4-Dichlorophenoxy)butanoic acid (3,4-DB); cloprop; 2-(4-Chlorophenoxy)propanoic acid (4-CPP); dichlorprop; chlora-zifop; clodinafop; clofop; cyhalofop; kuicaoxi; metamifop; propaquizafop; quizalofop; difenzoquat; halosulfuron; fluazolate; brompyrazon; clopyralid; diflufenican; atrazine; chlorazine; cyanazine; cyprazine; trietazine; indaziflam; ametryn; methoprotryne; simetryn; terbutryn; ethiozin; hexazinone; metribuzin; amicarbazone; bencarbazone; carfentrazone; sulfentrazone; thiencarbazone; cloransulam; isoproturon; methiuron; metobromuron; metoxuron; tetrafluron; thidiazuron; amidosulfuron; cyclosulfamuron; ethoxysulfuron; flucetosulfuron; metsulfuron; prosulfuron; thifensulfu-ron; tebuthiuron; acrolein; flurtamone; fluthiacet-methyl; funaihecaoling; agriculturally acceptable esters thereof; and mixtures of two or more thereof, wherein the second active ingredient is different from the third active ingredient.
